(19) United States
(12) Patent Application Publication
(10) Pub. No.: US 2017/0370638 A1
(43) Pub. Date: Dec. 28, 2017

(54) SYSTEM AND METHOD FOR IMPROVING THE LIQUEFACTION RATE IN CRYOCOOLER-BASED CRYOGEN GAS LIQUIFIERS

(71) Applicants: Universidad de Zaragoza, Zaragoza (ES); Consejo Superior de Investigaciones Cientificas, Madrid (ES)

(72) Inventors: Conrado Rillo Millan, Madrid (ES); Javier Sese Monclus, Zaragoza (ES)

(21) Appl. No.: 15/627,863

(22) Filed: Jun. 20, 2017

(30) Foreign Application Priority Data
Jun. 24, 2016 (EP) EP16382300.8

(51) Int. Cl. F25J 1/00; G05D 16/20; F25B 9/12; F25J 1/02

(52) U.S. Cl. CPC F25J 1/0007; F25J 1/0225; G05D 16/206; F25B 9/12; F25J 1/0276; F25J 2270/912; F25J 2270/908

(57) ABSTRACT

The present invention relates to a cryogen-gas liquefaction system (1) and method comprising: a storage container (2) comprising a liquid storage portion (3) and a neck portion (4) with a liquefaction region (8) above said bath (7); a coldhead (9) arranged at the neck portion (4) comprising one or more refrigeration stages (10, 11); a gas intake module (12) containing an amount of gas-phase cryogen for its introduction into the storage container (2); and a pressure control mechanism (13) for controlling the cryogen gas pressure within the liquefaction region (8) of the storage container (2). Advantageously, the coldhead (9) further comprises: a refrigeration compressor (17) for distributing gas-phase cryogen inside the coldhead (9); one or more extraction orifices (22) communicating a gas circulation circuit inside the coldhead (9) with the external region of the refrigeration stages (10, 11), acting as pass-through ports (23); and a gas injection source (19) connected with the gas circulation circuit of said refrigeration compressor (17) through a gas injection valve (20), that maintains a total amount of gas constant in the compressor gas circuit, to compensate for the amount of gas extracted and liquefied through the extraction orifices (22).

### CROSS-REFERENCE TO RELATED APPLICATIONS

The present application claims priority to European Patent Application No. 16382300.8 filed on Jun. 24, 2016, the disclosure of which is incorporated herein by reference.

### STATEMENT RE: FEDERALLY SPONSORED RESEARCH/DEVELOPMENT

Not Applicable

### BACKGROUND OF THE INVENTION

### 1. Field of the Invention

The present invention relates generally to systems and methods for liquefaction of gases, and more particularly to such systems and methods adapted for obtaining improved liquefaction and performance efficiency. The main field of application of the invention is helium liquefaction technologies such as small-scale liquefiers of <100 liter/day liquefaction rates, based on closed-cycle cryocoolers.

### 2. Description of the Related Art

Helium is a scarce element on earth and its numerous scientific and industrial applications continue to drive a growing demand. For example, common uses of gas-phase helium include welding, lifting (balloons), and semiconductor or fiber optic manufacturing. In the liquid phase, common uses include refrigeration of certain medical and scientific equipment, purging fuel tanks and basic research in solid-state physics, magnetism, and a wide variety of other research topics. Because of the widespread utility of helium and its limited availability, it is considered a high-cost non-renewable resource. Accordingly, there is an increasing interest in recycling helium and other similar noble gases.

In particular, liquid helium is used as the refrigerant in many applications in which it is necessary to reach temperatures below 20 K. Such applications are frequently related to the use of superconductors, and particularly in low-temperature physics research equipment, which operates in evacuated and insulated containers or vacuum flasks, called Dewars or cryostats. Such cryostats contain a mixture of both the gas and liquid phases and, upon evaporation, the gaseous phase is often released to the atmosphere. Therefore it is often necessary to purchase additional helium from an external source to continue the operation of the equipment in the cryostat.

One of liquid helium's most important applications is to refrigerate the high magnetic field superconducting coils used in magnetic resonance imaging (MRI) equipment, which provides an important diagnostic technique by non-invasively creating images of the internal body for diagnosing a wide variety of medical conditions in human beings.

The largest users of liquid helium are large international scientific facilities or installations, such as the Large Hadron Collider at the CERN international laboratory. Laboratories such as CERN recover, purify, and re-liquefy the recovered gas through their own large scale (Class L) industrial liquefaction plants, which typically produce more than 100 liters/h and require input power of more than 100 kW. For laboratories with more moderate consumption, medium (Class M) liquefaction plants are available that produce about 15 liters/hour. These large and medium liquefaction plants achieve a performance, R, of about 0.5-1 liter/hour/kW (12-24 liters/day/kW) when the gas is pre-cooled with liquid nitrogen, and about 0.25-0.5 liters/hour/kW (6-12 liters/day/kW) without pre-cooling.

For smaller scale applications, small-scale refrigerators are now commercially available which are capable of achieving sufficiently low temperatures to liquefy a variety of gases and, in particular, to liquefy helium at cryogenic temperatures below 4.2 K. In the industry, these small-scale refrigerators are normally referred to as closed-cycle cryocoolers. These cryocoolers have three components: a coldhead (a portion of which is called the “cold finger” and typically has one or two refrigeration stages), where the coldest end of the cold finger achieves very low temperatures by means of the cyclical compression and expansion of helium gas; a helium compressor which provides high pressure helium gas to and accepts lower pressure helium gas from the coldhead; and high and low pressure connecting hoses which connect the coldhead to the helium compressor. Each of the one or more cooling stages of the cold finger has a different diameter to accommodate variations in the properties of the helium fluid at various temperatures. Each stage of the cold finger comprises an internal regenerator and an internal expansion volume where the refrigeration occurs at the coldest end of each stage.

As a result of the development of these cryocoolers, various small-scale (“class S”) liquefaction systems have become commercially available in the last years, such as for example the system disclosed in patent application WO 2011/139989 A2 or the system disclosed in U.S. Pat. No. 8,671,698 B2. In these liquefiers, the gas to be liquefied cools by thermal exchange with either the cold stages of the cryocooler, or with heat exchangers attached to the cold stages of the cryocooler. In these small-scale liquefiers, a cryocooler coldhead operates in the neck of a double-walled container (a Dewar), which contains only the gas to be liquefied and is thermally insulated to minimize the flow of heat from the outside to the inside of the container. After the gas condenses, the resulting liquid is stored inside the inner tank of the Dewar.

FIG. 1 illustrates a general phase diagram of helium in which different liquefaction trajectories are indicated, based on prior art (see, for example, patent application WO 2011/139989 A2, or the article “Enhancement of the Liquefaction Rate in Small-Scale Helium Liquefiers Working Near and Above the Critical Point”, published in Phys Rev. Applied 3, 051001 (2015)). Starting with commercial or recovered gas at room temperature (300 K) and pressures in the range 100 kPa-250 kPa, the gas is cooled at constant pressure, thus passing through single phase He vapor points like AV, BV, or CV depending on the initial gas pressure. By further cooling this vapor following the indicated trajectories, the liquefier can produce two-phase liquid (point Z1) at around 4.2 K and 1 bar (100 kPa), a liquid that is ready to be transferred to, for example, MRI equipment. If the liquefier gets full of liquid, and the liquid is not needed immediately, it is advantageous to produce single-phase supercooled liquid (e.g. point AL) that can be transferred to equipment more efficiently than two-phase liquid. In reference to the liquefaction curves of FIG. 1, CVCLBLAAL represents a possible trajectory of high performance. The optimal liquefaction pressure is typically around the critical pressure, Z2, that is, 2.1 bar for the case of helium, a pressure for which liquefaction rates can reach and surpass 65 liters/day, equivalent to more than 30 liters/day at 4.2 K, with efficiencies approaching 4 liters/day/kW.

Ideally such small-scale liquefiers based on a cryocooler would achieve efficiencies comparable to that of the large and medium scale liquefiers. However, in practice, the achievable liquefaction performance (in terms of liters/day/kW) is significantly less for these small-scale liquefiers (<4 liters/day/kW) than the performance obtained with the larger Class M and Class L liquefaction plants (>6-12 liters/day/kW). The evolution in performance of prior art during the last 25 years is illustrated by Rillo et al. IEEE/CSC & ESAS European Superconductivity News Forum, No. 33, July 2015. Accordingly, there is a need of novel solutions allowing a further performance improvement of small-scale liquefiers. The present invention proposes a solution to said need.

### BRIEF SUMMARY OF THE INVENTION

Currently available small-scale liquefaction plants for producing less than 100 liters of liquefied cryogen per day, or “Class S” liquefiers, are substantially inefficient when compared to performances obtained by larger scale liquefaction plants. In addition, the medium and large-scale plants involve substantial complexity, require extensive maintenance and their liquefaction rates, >15 liters/hour (i.e. >360 liters/day)), are far in excess of the needs of many users.

In a first attempt to accomplish better efficiencies, the gas liquefaction system of the previous art described in patent application WO 2011/139989 A2 and in Phys Rev. Applied 3, 051001 (2015)) was adapted with means for controlling pressure within a liquefaction region of the system such that an elevated pressure provides operation at increased liquefaction temperature as described in the above references. By precisely controlling gas flowing into the system, an internal liquefaction pressure could be maintained at an elevated threshold. At the elevated pressure, around the critical pressure for optimum performance, the increased cooling power of the coldhead was utilized, and, unprecedented liquefaction rate values as large as 4 liters/day/kW, more than 100% higher than previous art, were obtained (Rillo et al. IEEE/CSC & ESAS European Superconductivity News Forum, No. 33, July 2015, and Chialvo et al. Proceedings of the 18th International Cryocooler Conference, 2014, pp. 551-556).

It is thus an object of the present invention to provide a gas liquefaction system and method based on cryocoolers, adapted to utilize the thermodynamic properties of gaseous elements to extract increased cooling power from the cryocooler in order to improve the liquefaction rate and performance of the already known systems.

A liquefaction region is herein defined as a volume within the Dewar including a first cooling region adjacent to a first stage of a cryocooler where gas entering the system is initially cooled, and a second condensation region adjacent to a second or subsequent stage of the cryocooler where the cooled gas is further cooled and condensed into a liquid-phase. Thus, for purposes of this invention, the liquefaction region includes the neck portion of the Dewar and extends to the storage portion where liquefied cryogen is stored. In various embodiments of the invention, the system further comprises means for controlling pressure inside the Dewar, which can include a unitary pressure control module being adapted to regulate an input gas flow for entering the liquefaction region, such that pressure within the liquefaction region is precisely maintained during a liquefaction process. Alternatively, a series of pressure control components selected from solenoid valves, a mass flow meter, pressure regulators, and other pressure control devices may be individually disposed at several locations of the system such that a collective grouping of the individualized components is adapted to provide control of an input gas entering into the liquefaction region of the system.

Moreover, in order to further optimize the heat exchange between the gas and the various refrigeration elements of the liquefaction system, the proposed invention takes advantage of the already cooled gas circulating inside the coldhead of the cryocooler, by extracting small volumes of said gas from the coldest part of the coldhead, without altering its functioning. This already liquefied gas is added into the liquefaction region of the storage container, thereby increasing the average liquefaction rate of the system while temperature and pressure inside the storage container are kept constant by means of a control mechanism.

The aforementioned liquefaction improvements are achieved by a gas liquefaction system for liquefying gas comprising:

a storage container comprising a liquid storage portion and a neck portion extending therefrom, the liquid storage portion being adapted to contain a liquefied gas bath at the bottom of the storage container and comprising a liquefaction region above said bath, wherein the gas to be liquefied exchanges heat with the liquefaction system;

a coldhead arranged at the neck portion comprising one or more refrigeration stages; a pressure control mechanism for controlling the cryogen gas pressure within the liquefaction region of the storage container.

Advantageously, the cryocooler's coldhead of the system further comprises:

a refrigeration compressor for distributing compressed gas-phase cryogen inside the coldhead, wherein said cryogen gas is supplied to and returned from the coldhead and acts as refrigeration means for lowering the temperature of one or more refrigeration stages of the coldhead;

one or more extraction orifices communicating the gas circulation circuit inside the coldhead with the external region of the refrigeration stages, acting as pass-through ports which allow the gas inside the coldhead to flow out into the liquefaction region of the storage container; and

a gas injection source connected with the gas circulation circuit of said refrigeration compressor through a gas injection valve, wherein said gas injection valve is used for controlling the pressure within the coldhead.

The system according to the present invention is adapted to maintain precise control over the vapor pressure inside the container, and thus is adapted to maintain precise control of the temperature and hence the power of the cryocooler where condensation is produced. Consequently, the system allows control of the operating point of the cryocooler, as determined by the temperatures of its one or more stages, and, thereby, of the amount of heat that can be extracted by the gas being liquefied, both for its pre-cooling from room temperature to the point of operation, and for its condensation and liquefaction.

In a preferred embodiment of the present invention, the storage container is insulated by a shell with the volume within the shell external of the storage portion being substantially evacuated of air.

In yet another preferred embodiment of the present invention, the storage container further comprises a transfer port extending from the liquid storage portion to an external surface of the storage container.

In yet another preferred embodiment of the present invention, the system further comprises a gas source module containing an amount of gas-phase cryogen for its introduction into liquefaction region of the storage container.

In yet another preferred embodiment of the present invention, the system further comprises a level meter for measuring the volume of liquid within the storage container.

In yet another preferred embodiment of the present invention, the pressure control mechanism comprises one or more of the following components:

a pressure sensor for measuring the pressure values within the liquefaction region of the storage container;

a pressure regulator for regulating pressure of gas entering the liquefaction region of the storage container;

a mass flow meter;

one or more valves for regulating input gas flow entering the liquefaction region.

In yet another preferred embodiment of the present invention, the pressure control mechanism is further connected to a computer for dynamically modulating input gas flow and/or pressure within the liquefaction region of the storage container.

In yet another preferred embodiment of the present invention, the extraction orifices have a diameter of 0.5-5.0 mm.

In yet another preferred embodiment of the present invention, the extraction orifices are performed over one or more refrigeration stages of the coldhead and attached thereto through fixing means comprised in the pass-through ports. More preferably, the pass-through ports comprise insulating seals to prevent undesired gas flow through said fixing means.

In yet another preferred embodiment of the present invention, one or more pass-through ports comprise a configurable cryogenic flow valve. Preferably, the closed/open configuration of said cryogenic valve is operated by traction means and/or compression means and, more preferably, the pass-through port and the cryogenic valve can optionally be connected through a capillary tube.

In yet another preferred embodiment of the present invention, the cryogen gas is any of: helium, nitrogen, oxygen, hydrogen, neon. More preferably, the gas contained in the gas intake module and, the gas contained in the gas injection source are both high purity helium gas, recovered from helium-using equipment and purified.

Another aspect of the invention relates to a gas liquefaction method that makes use of the gas liquefaction system disclosed in the present application, which comprises the following steps:

(i) providing at least:

a storage container having a liquefaction region and defined by a storage portion and a neck portion extending therefrom;

a pressure control mechanism for controlling the pressure within the liquefaction region of the storage container;

a cryocooler's coldhead at least partially disposed within the neck portion, the coldhead being adapted to condense cryogen contained within the liquefaction region from a gas-phase to a liquid-phase;

wherein the cryocooler's coldhead comprises:

a refrigeration compressor for distributing cold compressed gas-phase cryogen inside the coldhead, wherein said cryogen is supplied to and returned from the coldhead and acts as refrigeration means for lowering the temperature of one or more refrigeration stages of the coldhead;

one or more extraction orifices communicating a gas circulation circuit inside the coldhead with the external region of the refrigeration stages, acting as pass-through ports which allow the gas inside the coldhead to flow to the liquefaction region of the storage container;

a gas injection source connected with the gas circulation circuit of said compressor, wherein the gas injection source is connected to the pressure control mechanism by means of a gas injection valve for controlling the pressure within the coldhead through a PLC connected thereto;

(ii) measuring and controlling the vapor pressure within said liquefaction region of the storage container with the pressure control mechanism and the PLC, and the internal pressure within the coldhead with the gas injection valve (20) and PLC;

(iii) maintaining the vapor pressure within said liquefaction region of the storage container by means of the pressure controller, and maintaining the internal pressure within the coldhead within an operating range by means of the gas injection source, and the injection valve.

In a preferred embodiment of the present invention, the proposed gas liquefaction method further comprises the step of injecting gas into the liquefaction region of the storage container with a gas source, in collaboration with the pressure controller of the storage container, for maintaining the vapor pressure during step (iii).

In sum, the gas liquefaction system and method proposed by the present invention achieve much higher efficiencies than existing cryocooler-based liquefiers by providing improved heat exchanging means between the gas and the various refrigeration elements of the liquefaction system, extracting small volumes of said gas from the coldhead and injecting them in the liquefaction region of the storage container. The liquefaction efficiency of the system is further enhanced and stabilized by precisely controlling the pressure of the room temperature gas entering the liquefaction region, and thereby precisely controlling the pressure of the condensing gas in the liquefaction region of the system.

### BRIEF DESCRIPTION OF THE DRAWINGS

The characteristics and advantages of this invention will be more apparent from the following detailed description, when read in conjunction with the accompanying drawings, in which:

FIG. 1 shows a phase diagram of helium and prior art liquefaction P-T trajectories, according to prior art technologies.

FIG. 2 shows a schematic diagram of a known prior art helium liquefaction system.

FIGS. 3a and 3b show schematic diagrams of two preferred embodiments of the liquefaction system according to the invention.

FIG. 4 shows the schematic diagram of an example of the cryogenic elements to implement gas extraction from the coldhead, applied to a liquefaction system according to the diagram of FIGS. 3a-3b, represented in open (FIG. 4a) and closed (FIG. 4b) positions.

FIG. 5 shows a liquefaction test carried out with a system according to the preferred embodiment of FIGS. 3-4, for the case of a 160-liter storage container, and compared with prior art.

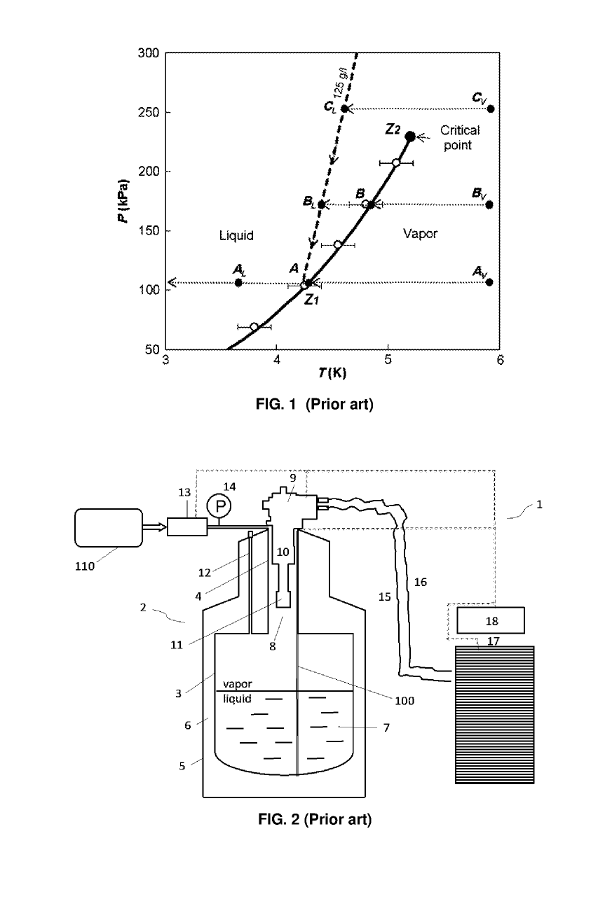

### DETAILED DESCRIPTION OF THE INVENTION

In the following description, for purposes of explanation and not limitation, details are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

In a general embodiment according to FIG. 2, a known liquefaction system (1), also referred to herein as a cryostat, includes an isolated storage container (2) or Dewar comprising a liquid storage portion (3) and a neck portion (4) extending therefrom, and connected to an outer vessel (5) which is at ambient temperature. The storage container (2) is insulated by a shell (6) with the volume within the shell (6) external of the storage portion (3) being substantially evacuated of air. Also, in order to measure the volume of liquid within the storage container (2), the system can optionally include a level meter (100).

The storage portion (3) is adapted to contain a liquefied gas bath (7) at the bottom of the storage container (2) and a liquefaction region (8) above said bath (7), wherein the gas to be liquefied exchanges heat with the liquefaction system (1). In order to do so, the neck portion (4) is adapted to at least partially receive a cryocooler coldhead (9). The coldhead (9) may comprise one or more refrigeration stages (10, 11), each preferably having a distinct cross section. The neck portion (4) of the storage container (2) may be optionally adapted to geometrically conform to the one or more refrigeration stages (10, 11) of the cryocooler coldhead (9) in a stepwise manner. The storage container (2) further comprises a transfer port (12) extending from the liquid storage portion (3) to an external surface of the storage container (2). A forward pressure control mechanism (13) that integrates a mass flow meter and a proportional valve (FPC) is further provided for controlling gas flow and thereby pressure within the liquefaction region (8) of the storage container (2). The forward pressure control mechanism (13) generally includes a pressure regulator or other means for regulating pressure of gas entering the liquefaction region (8) of the storage container (2). The pressure control mechanism (13) also makes use of an external pressure sensor (14), or integrates it, for detecting pressure within the liquefaction region (8) of the storage container (2). In this regard, the control mechanism (13) is further connected to a computer Programmable Logic Controller (PLC) (18) (or equivalently, any suitable computing or processing means) for dynamically modulating input gas flow, and hence, pressure within the liquefaction region (8) of the storage container (2) for yielding optimum efficiency.

It should be recognized that although depicted as a distinct unit in several descriptive embodiments herein, the components of the pressure control mechanism (13) can be individually located near other system components and adapted to effectuate a similar liquefaction process. Accordingly, the pressure control mechanism (13) is intended to include a collection of components in direct attachment or otherwise collectively provided within the system (1) for dynamically controlling input gas flow, and thus pressure within the liquefaction region (8) of the storage container (2).

As referred in preceding sections, in the known liquefaction systems according to FIG. 2 the coldhead (9) comprising one or more stages (10, 11) operates in the neck portion (4) of the storage container (2) or Dewar. A first stage (10) is the warmest and operates in the neck portion (4) further from the liquefaction region (8) than the other stages (11). Thus, the gas enters at the warm end of the neck portion (4) and is pre-cooled by the walls of the first stage (10) of the coldhead (9), by the coldest end of the first stage (10), further pre-cooled by the walls of the colder stages (11), and is then condensed at the coldest end of the coldest stage (11) of the coldhead (9). For a one-stage coldhead (9) embodiment, the condensation occurs at the coldest end of the first stage (10). Once condensed, the liquefied gas falls by gravity from the liquefaction region (8) down to the bath (7) at the bottom of the storage portion (3) in the interior of the storage container (2). The cooling power that each stage (10, 11) of a closed-cycle cryocooler generates, is determined mainly by its temperature, but also depends to second order on the temperature of the previous stages (10, 11). This information is generally supplied by the cryocooler manufacturer as a two-dimensional load map that plots the dependence of the power of the first (10) and second (11) stages versus the temperatures of the first and second stages (10, 11).

In addition to generating cooling power at the first (10) and second (11) stages, the coldhead (9) also generates cooling power along its entire length, in particular along the surface of the cylindrical cold finger between room temperature and the coldest end of the first stage (10), and along the length of the cylindrical cold finger between the stages (10, 11).

The liquefaction system (1) according to FIG. 2 also comprises a refrigeration compressor (17) for distributing cold compressed gas inside the coldhead (9), wherein said gas is supplied to and returned from the coldhead (9) via compressor hoses (15, 16) for supply pressure (15) and for return pressure (16), and acts as refrigeration means for lowering the temperature of the refrigeration stages (10, 11). In known small-scale helium liquefiers, the supply pressures are typically between 1.5-2.5 MPa and the return pressures are typically between 0.3-1 MPa. The distributed gas inside the compressor (17) will preferably be of the same type of the gas to be liquefied (for example, helium).

The system (1) of FIG. 2 is supplied primarily with gas from a gas source module (110), preferably being recovered gas from liquid a cryogen-using equipment. The gas source module (110) is connected to the storage container (2) and controlled by the pressure control mechanism (13). The condensation process of the cold vapor accumulating as liquid in the storage container (2) corresponds to an isobaric process during which any disturbance in pressure yields a diminished liquefaction rate. For the gas liquefaction system (1) to perform at optimum efficiency, it is therefore necessary to perform precise control of the interior pressure conditions, maintaining it throughout the entire process.

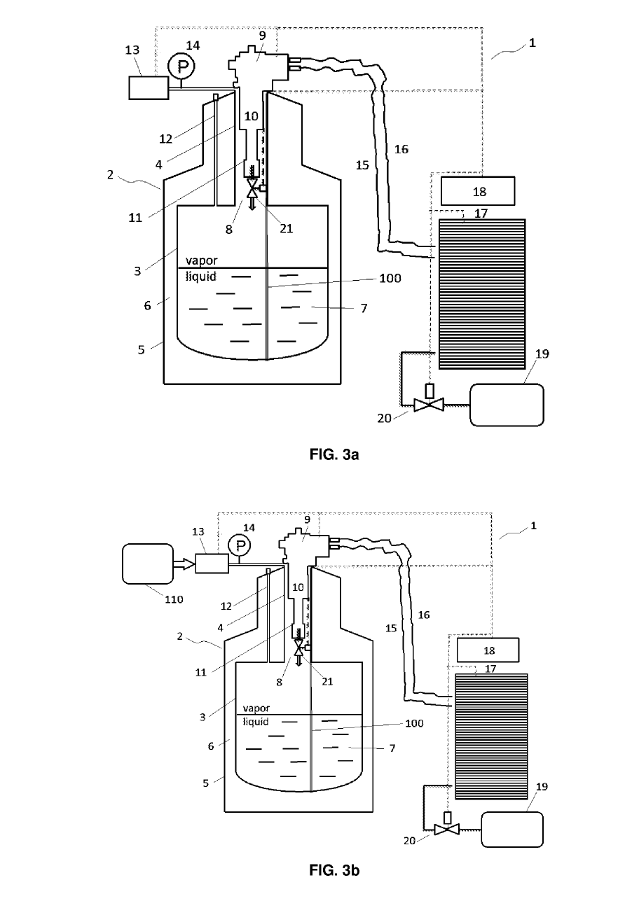

With the aim of improving the known liquefaction systems (1) in the art (FIG. 2), it is an object of this invention to optimize the heat exchange between the gas and the various refrigeration elements of the liquefaction system (1), as well as obtaining further auxiliary means for improving the liquefaction rate obtained through the cryocooler coldhead (9). In order to carry out the said object, FIG. 3a and FIG. 3b illustrate liquefaction systems (1) according to two preferred embodiments of the present invention. As described in precedent sections, the proposed liquefaction system (1) of the invention takes advantage of the already cooled gas circulating inside the cryocooler, by extracting small volumes of said gas from the coldest part of the coldhead (9), without altering its functioning. This already liquefied gas is added into the liquefaction region (8) of the storage container (2), thereby increasing the average liquefaction rate of the system (1) while maintaining the pressure inside the storage container (2) at a constant value by means of the pressure control mechanism (13), the pressure sensor (14) and/or the PLC (18). When referring to “small volumes” of gas extracted from the coldhead (9), without altering its functioning, these should be interpreted, within the scope of the invention, as volumes which do not alter the refrigeration operations or capacities of the compressor (17) over the coldhead (9) stages (10, 11), maintaining the temperature of the coldest stage (11) of the coldhead (9) stable, preferably at a constant value of substantially 4.2 K (for the case of helium liquefaction applications).

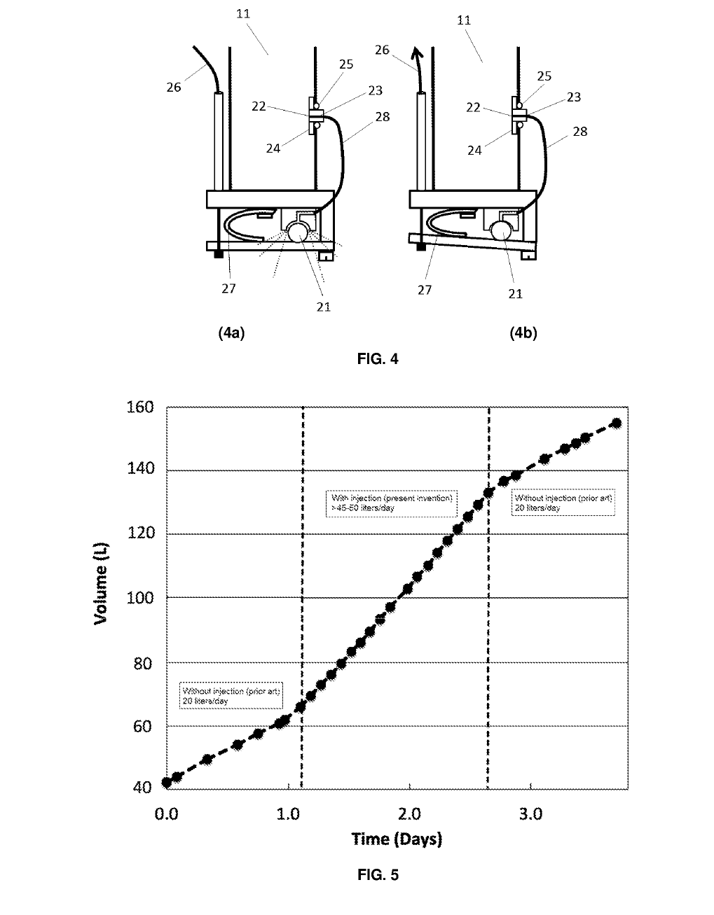

As depicted in FIGS. 3a-3b, the extraction of gas from the coldhead (9) is preferably carried out by a coldhead gas extraction cryogenic flow valve (21) subsystem, a detail of which is shown in FIG. 4, comprising one or more extraction orifices (22) communicating the gas circulation circuit inside the coldhead (9) with the external region of the refrigeration stages (10, 11). Thus, the extraction orifices (22) act as pass-through ports (23), which allow the gas inside the coldhead (9) to flow to the liquefaction region (8) of the storage container (2). More preferably, the extraction orifices (22) have a typical diameter of 0.5-5.0 mm for a small-size cryocooler coldhead (9).

The pass-through extraction orifices (22) can be performed over one or more refrigeration stages (10, 11) of the coldhead (9) by means of screws, rivets or analogous fixing means (24) and they can also comprise insulating seals (25) to prevent undesired gas flow through said fixing means (24).

In order to regulate the amount of gas flowing through the extraction orifices (22), each pass-through port (23) preferably comprises a configurable cryogenic flow valve (21). In different embodiments of the invention, the closed/open configuration of said cryogenic flow valve (21) can be operated by mechanical means, such as traction means (for example, through one or more Bowden cables (26)), compression means (for example, through one or more springs (27)), or the like. The pass-through port (23) and the cryogenic flow valve (21) can optionally be connected through a capillary tube (28).

In a preferred embodiment of the invention, in order to keep the gas pressure at constant values within the compressor (17), the system (1) of the invention comprises also a gas injection source (19) connected with the gas circulation circuit of said compressor (17) through a gas injection valve (20). More preferably, the gas injection source (19) is connected with the return stage (16) of the compressor's circuit. The use of a gas injection source (19) allows keeping the gas amount constant within the compressor (17), thereby stabilizing its internal pressure. The monitoring of the pressure conditions within the coldhead (9) can be performed by the programmable logic controller (18) of the system (1), which receives the necessary data needed to perform the control of the gas injection valve (20). All functions and procedures are controllable remotely or in situ, using programmable devices, such as personal computers or further programmable logic controllers), with specific control software, or connected to digital storage hardware in which such software is stored and remotely accessed.

In another general embodiment, a method for liquefaction of gas is provided in conjunction with the described liquefaction system (1) of the invention. The method preferably comprises:

(i) providing at least:

a storage container (2) having a liquefaction region (8) and defined by a storage portion (3) and a neck portion (4) extending therefrom;

a pressure control mechanism (13) for controlling the pressure within the liquefaction region (8) of the storage container (2);

a cryocooler's coldhead (9) at least partially disposed within the neck portion (4), the coldhead (9) being adapted to condense cryogen contained within the liquefaction region (8) from a gas-phase to a liquid phase;

optionally, a gas source module (110) containing an amount of gas-phase cryogen; wherein the cryocooler' s coldhead (9) comprises:

a refrigeration compressor (17) for distributing cold compressed gas-phase cryogen inside the coldhead (9), wherein said cryogen is supplied to and returned from the coldhead (9) and acts as refrigeration means for lowering the temperature of one or more refrigeration stages (10, 11) of the coldhead (9);

one or more extraction orifices (22) communicating a gas circulation circuit inside the coldhead (9) with the external region of the refrigeration stages (10, 11), acting as pass-through ports (23) which allow the gas inside the coldhead (9) to flow to the liquefaction region (8) of the storage container (2);

a gas injection source (19) connected with the gas circulation circuit of said compressor (17) through a gas injection valve (20) that is connected to a PLC (18) for controlling the pressure within the coldhead (9);

(ii) measuring and controlling the vapor pressure within said liquefaction region (8) of the storage container (2) with the pressure control mechanism (13), and the internal pressure within the coldhead (9) with the gas injection valve (20);

(iii) maintaining the vapor pressure within said liquefaction region (8) of the storage container (2) with the pressure controller (13), and the internal pressure within the coldhead (9) within an operating range with the gas injection valve (20) from the gas injection source (19);

(iv) optionally, injecting gas into the liquefaction region (8) of the storage container (2) with a gas source module (110) in collaboration with the pressure controller (13) for maintaining the vapor pressure during step (iii).

Although in principle the present invention allows the use of any multi-stage cryocooler coldhead (9), the following description is directed to an embodiment comprising a coldhead with two refrigeration stages (10, 11). Nonetheless, it should be apparent to the person skilled in the art that the application to other types of coldheads (9) (equipped with one, two, or more refrigeration stages (10, 11)) is analogously achievable with equivalent increase in the liquefaction rates.

In order to illustrate the efficiency improvement achieved by the present invention, FIG. 5 shows a liquefaction test carried out with a system (1) according to FIG. 3b, for the case of a 160-liter storage container (2), equipped with one orifice of 3 mm performed at the second refrigeration stage (11). The gas stored in the container (2) and the gas flowing in the compressor (17) circuit is helium. The figure shows two prior art modes of operation wherein the extraction cryogenic flow valve (21) remains closed, thereby without allowing gas injection from the compressor (17) circuit to the storage container (2). The liquefaction rates obtained are 19-20 liters/day. Between the slow modes, an “injection mode” of operation is also shown where the cryogenic flow valve (21) is opened and pre-cooled helium from inside the coldhead (9) is injected into the liquefaction region (8) of the storage container (2). With this further supply of cooling medium from the gas source (19), liquefaction rate is highly enhanced. The data represented in FIG. 5 show a substantial increase of the liquefaction rate which rises from below 20 liters/day (3 liters/day/kW) to above 45 liters/day (7 liters/day/kW), thus, yielding a performance R equivalent to that of industrial liquefactions plants. Compressor (17) internal pressure values are controlled throughout the whole liquefaction process by means of the injection valve (20) at the desired value set on PLC (18). In this mode of operation, constant liquefaction pressure within the storage container is maintained, if needed, by further supplying helium to the storage container (2) from the gas source module (110). The pressure inside the storage container was maintained at 107 kPa, i.e. around atmospheric pressure, during the whole test.

1. A cryogen-gas liquefaction system comprising:
a storage container comprising a liquid storage portion and a neck portion extending therefrom, the liquid storage portion being adapted to contain a liquefied gas bath at the bottom of the storage container and comprising a liquefaction region above said bath, wherein the gas to be liquefied exchanges heat with the liquefaction system;
a coldhead arranged at the neck portion comprising one or more refrigeration stages;
a pressure control mechanism for controlling the cryogen gas pressure within the liquefaction region of the storage container;
characterized in that the coldhead further comprises:
a refrigeration compressor for distributing compressed gas-phase cryogen inside the coldhead, wherein said cryogen gas is supplied to and returned from the coldhead and acts as refrigeration means for lowering the temperature of one or more refrigeration stages of the coldhead;
one or more extraction orifices communicating a gas circulation circuit inside the coldhead with the external region of the refrigeration stages, acting as pass-through ports which allow the gas inside the coldhead to flow out to the liquefaction region of the storage container;
a gas injection source connected with the gas circulation circuit of said refrigeration compressor through a gas injection valve, wherein said gas injection valve is used for controlling the pressure within the coldhead.

2. The liquefaction system according to claim 1, further comprising a gas source module containing an amount of gas-phase cryogen for its introduction into liquefaction region of the storage container.

3. The liquefaction system according to claim 1, further comprising a level meter for measuring the volume of liquid within the storage container.

4. The liquefaction system according to claim 1, wherein the storage container further comprises a transfer port extending from the liquid storage portion to an external surface of the storage container.

5. The liquefaction system according to claim 1, wherein the pressure control mechanism comprises a pressure sensor for measuring the pressure values within the liquefaction region of the storage container.

6. The liquefaction system according to claim 1, wherein the pressure control mechanism is further connected to a PLC adapted for dynamically modulating input gas flow and/or pressure within the liquefaction region of the storage container.

7. The liquefaction system according to claim 1, wherein the extraction orifices have a diameter of 0.5-5.0 mm.

8. The liquefaction system according to claim 1, wherein the extraction orifices are performed over one or more refrigeration stages of the coldhead and attached thereto through fixing means comprised in the pass-through ports, optionally in combination with insulating seals to prevent undesired gas flow through said fixing means.

9. The liquefaction system according to claim 1, wherein one or more pass-through ports comprise a configurable cryogenic flow valve.

10. The liquefaction system according to claim 9, wherein the closed/open configuration of said cryogenic flow valve is operated by traction means and/or compression means.

11. The liquefaction system according to claim 9, wherein the pass-through ports and the cryogenic flow valve are connected through a capillary tube.

12. The liquefaction system according to claim 1, wherein the cryogen gas within the storage container and/or within the compressor is helium.

13. The liquefaction system according to claim 1, wherein the gas contained in the gas intake module and the gas contained in the gas injection source are both high purity helium gas, recovered from helium-using equipment and purified.

14. A cryogen-gas liquefaction method for use in a system according to any of the preceding claims, characterized in that it comprises the following steps:
(i) providing at least:
a storage container having a liquefaction region and defined by a storage portion and a neck portion extending therefrom;
a pressure control mechanism for controlling the pressure within the liquefaction region of the storage container;
a cryocooler's coldhead at least partially disposed within the neck portion, the coldhead being adapted to condense cryogen contained within the liquefaction region from a gas-phase to a liquid-phase;
a gas injection source containing an amount of gas-phase cryogen;
wherein the cryocooler's coldhead comprises:
a refrigeration compressor for distributing cold compressed gas-phase cryogen inside the coldhead, wherein said cryogen is supplied to and returned from the coldhead and acts as refrigeration means for lowering the temperature of one or more refrigeration stages of the coldhead;
one more extraction orifices communicating the gas circulation circuit inside the coldhead with the external region of the refrigeration stages, acting as pass-through ports which allow the gas inside the coldhead to flow to the liquefaction region of the storage container;
a gas injection valve connecting the gas injection source with the gas circulation circuit of said compressor for controlling the pressure within the coldhead through a PLC connected thereto;
(ii) measuring and controlling the vapor pressure within said liquefaction region of the storage container with the pressure control mechanism and the PLC, and the internal pressure within the coldhead with the gas injection valve and PLC;
(iii) maintaining the vapor pressure within said liquefaction region of the storage container by means of the pressure controller, and maintaining the internal pressure within the coldhead within an operating range by means of the gas injection source, and the injection valve.

15. The method according to claim 14, further comprising the step of injecting gas into the liquefaction region of the storage container with a gas source module, in collaboration with the pressure controller for maintaining the vapor pressure during step (iii).
